(19) United States
(12) Patent Application Publication
(10) Pub. No.: US 2001/0007630 A1
(43) Pub. Date: Jul. 12, 2001

(54) Substrate transfer system and substrate processing apparatus

(76) Inventors: Yoshihiro Katsumata, Tokyo (JP); Kazuhito Watanabe, Tokyo (JP); Nobuyuki Takahashi, Tokyo (JP)

Correspondence Address: KANESAKA AND TAKEUCHI, 1423 Powhatan Street, Alexandria, VA, 22314, US

(21) Appl. No.: 09/757,684

(22) Filed: Jan. 11, 2001

(30) Foreign Application Priority Data
Jan. 12, 2000 (JP) 2000-3850

(51) Int. Cl. B65G 1/00

(52) U.S. Cl. 414/217

(57) ABSTRACT

This invention presents a substrate transfer system comprising a transfer robot which transfers a substrate, and a retainer which temporarily retains the substrate while the substrate is transferred. The transfer robot has an arm at which fore end a substrate support for supporting the substrate is provided, and a driver which makes the arm perform expansion, contraction, rotation and lifting motion, thereby transferring the substrate to a position. The substrate is retained temporarily with the retainer while the transfer robot rotates the arm and the substrate support together to change the direction of the expansion and the contraction motion of the arm. This invention also presents a substrate processing apparatus comprising a process chamber in which a process is carried out on the substrate, a load lock chamber in which the substrate stays temporarily while it is transferred to the process chamber, and a transfer chamber in which a substrate transfer system is provide. The substrate transfer system transfers the substrate between the load lock chamber and the process chamber.

### BACKGROUND OF THE INVENTION

This invention relates to a substrate transfer system which transfers the substrate. In addition, this invention relates substrate processing apparatus in which a substrate transfer system is provided.

Apparatuses which carry out a process on a substrate are well known as thin-film deposition apparatuses, etching apparatuses, surface oxidation apparatuses or surface nitriding apparatuses. As thin-film deposition apparatuses, such apparatuses as sputtering apparatuses and chemical vapor deposition (CVD) apparatuses are well known.

Such substrate processing apparatuses are widely used for production of electron devices like LSIs (large scale integrated circuits) and display devices like LCDs (liquid crystal displays). Such substrate processing apparatuses have an airtight process chamber to process the substrate in a specified atmosphere. A load lock chamber is connected with the process chamber so that the process chamber may not be opened directly to the atmosphere when the substrate is transferred between the process chamber and the atmosphere.

In addition, a substrate transfer system which transfers the substrate between the load lock chamber and the process chamber is provided. For the substrate transfer system, a robot with an articulated arm is usually used, because it can transfer the substrate to a position in a three-dimensional space freely nevertheless its occupation space is comparatively small. The arm of the robot has a substrate support at its fore end, on which the substrate is supported. The robot (hereinafter called, “transfer robot”) transfers the substrate by making the arm perform an expansion, contraction, rotation and lifting motion respectively. The substrate support is a board-shaped member, on which the substrate is put.

In the described substrate transfer system, one problem arises with respect to that the arm is made to perform the rotation. When the arm performs the rotation while the substrate support supports the substrate, the substrate may shift on the substrate support from the inertia or the centrifugal force. If the substrate shifts on the substrate support, the substrate cannot be transferred to a potion in the process chamber rightly, resulting in that problems such as the transferring error and decrease of the reproducibility may arise. When it is worst, the substrate falls from the substrate support, resulting in that it is made disabled from being used. If such the accident happens after many processes have already been carried out on the substrate, it leads the much loss, thus the yield greatly decreases

As a method for solving the described problem, it may be adopted to weaken influences of the inertia and the centrifugal force by reducing the speed in the rotation. However, reducing the speed means that the transferring time is lengthened, resulting in that the productivity decreases.

As another method, the substrate may be chucked electro-statically with the substrate support by inducing the static-electricity on the surface of the substrate support. However, with this method, the possibility that particles like dusts in the circumference adhere to the substrate may increase, because those are extracted electro-statically to the substrate. “Particle” in this specification means minute substance such as atom, molecule, grain or fragment, which contaminates the substrate in general. There is a further problem that the substrate is flawed, releasing fragments which may become the particles, when the substrate is chucked electro-statically with the substrate support.

As another method, the substrate may be chucked with the substrate support by vacuum. However, when the substrate is transferred in a vacuum atmosphere, i.e., the substrate transfer system is used in the vacuum, that solution cannot be adopted.

The described problem that the substrate shifts during the rotation is serious in relation with tendency that size of the substrate becomes larger, which is recently prominent. In the manufacture of electronic devices like LSIs, a larger size substrate tends to be used, on purpose that the productivity can be improved by increasing the number of devices produced from one substrate. In addition, in the production of display devices like LCDs, a larger size substrate tends to be used from the request to make screen size larger. When a larger size substrate is used, the sift of the substrates is easier to occur, because the centrifugal force increases or the contact area of the substrate support and the substrate is diminished.

In addition, the rotation of the arm supporting the substrate brings another problem in relation with whole occupation area of the apparatus. The rotation in general requires a circular space which radius corresponds to the distance between the center of the rotation and the position farthest from the center of rotation at an object to be rotated. This radius is hereinafter called “the required minimum radius”. In case the arm supporting the substrate is rotated, the required minimum radius is the distance between the center of the rotation and the edge of the substrate. When the arm supporting the substrate is rotated, the required minimum radius is wide, which means that a broader space is required, although the required minimum radius of the arm itself is comparatively small. This does not respond to the request for whole space saving of the apparatus. This problem is furthermore serious from the described tendency of the substrate size enlargement. If the substrate size is larger and larger, then the required minimum radius increases more and more, resulting in that the occupation area of the transfer chamber increases. This leads to the occupation area increase of the whole apparatus.

### SUMMARY OF THE INVENTION

This invention is to solve the described problems. With this invention, the problems in the substrate transfer system with the transfer robot, which arises from the rotation of the arm, is effectively solved.

For this solution, this invention presents a substrate transfer system comprising a transfer robot which transfers a substrate, and a retainer which temporarily retains the substrate while the substrate is transferred. The transfer robot has an arm at which fore end a substrate support for supporting the substrate is provided, and a driver which makes the arm perform expansion, contraction, rotation and lifting motion, thereby transferring the substrate to a position. The substrate is retained temporarily with the retainer while the transfer robot rotates the arm and the substrate support together to change the direction of the expansion and the contraction of the arm, thus the rotation for changing the direction is performed without supporting the substrate.

This invention also presents a substrate processing apparatus comprising a process chamber in which a process is carried out on the substrate, a load lock chamber in which the substrate stays temporarily while it is transferred to the process chamber, and a transfer chamber in which a substrate transfer system is provide. The substrate transfer system transfers the substrate between the load lock chamber and the process chamber.

### BRIEF DESCRIPTION OF DRAWINGS

FIG. 1 is a schematic strabismus view showing a substrate transfer system of an embodiment of this invention.

FIG. 2 is a schematic plane view showing a substrate processing apparatus of an embodiment of this invention.

FIG. 3 is a schematic cross-sectional view explaining operation of the substrate processing apparatus shown in FIG. 2.

### DESCRIPTION OF THE PREFERRED EMBODIMENTS

The preferred embodiments of this invention are described as follows.

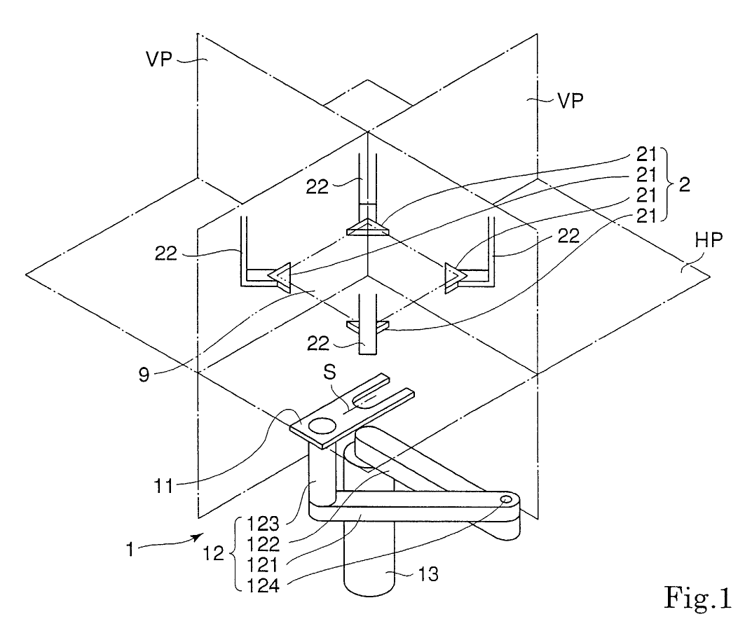

The substrate transfer system shown in FIG. 1 comprises a transfer robot 1 which transfers a substrate 9, and a retainer 2 which temporarily retains substrate 9 while substrate 9 is transferred.

Transfer robot 1 comprises arm 12 and driver 13. At the fore end of arm 12, substrate support 11 for supporting substrate 9 is provided. Driver 13 makes arm 12 perform the expansion, the contraction, the rotation and the lifting motion, thereby transferring substrate 9. Arm 12 is a kind of articulated arms, which has a structure where arm rods 121, 122 are connected through joints 123, 124.

Substrate support 11 is a plate of a nearly rectangular shape as shown in FIG. 1. Substrate support 11 has a U-shaped notch formed on the shorter side of the rectangle. The depth direction of U corresponds to the direction of the longer side of the rectangle. For convenience of the description, an imaginary line drawn through the center of the rectangle and directed to the direction of the longer side the rectangular is hereinafter called “support basis line”. The support basis line is designated by “S” in FIG. 1.

In this embodiment, arm 12 of transfer robot 1 consists of a couple of arm rods 121, 122. One is first arm rod 121 and the other one is second arm rod 122. Substrate support 11 is connected with the fore end of first arm rod 121 through the first joint 123. The back end of first arm rod 121 is connected with second arm rod 122 though second joint 124. Many kinds of robots as described are available from manufacturers. From those robots, adequate one is selected and used as transfer robot 1.

Retainer 2 is composed of four support-plates 21 in this embodiment. Each support-plate 21 has a right-angled triangle shape. In this embodiment, substrate 9 to be transferred is assumed square. Four support-plates 21 are provided to retain substrate 9 in the position in each angle of square substrate 9.

Each support-plate 21 is fixed with a frame which does not interfere with the motion of arm 12 of transfer robot 1. In this embodiment, fixation rod 22 which is vertically lengthened is adopted as the frame. The right-angle part of each support-plates is fixed at the lower end of each fixation rod 22, which is bent to the inside as shown in FIG. 1. The upper end of each fixation rod 22 is fixed with a fixation member provided above (not shown)

First joint 123, which connects substrate support 11 and first arm rod 121, is a vertically lengthened member as shown in FIG. 1. When arm 12 submits the expansion and the contraction in state that substrate support 11 supports substrate 9, first arm rods 121, second joint 124 and second arm rod 122 are located lower than each support-plate 21 and driven at a horizontal plane beneath each support-plate 21.

Operation of the substrate transfer system of the above composition is described as follows.

In FIG. 1, imaginary vertical planes designated by VP are drawn in FIG. 1. The perpendicular bisectors of the lines on which every two support-plates 21 are aligned belong to the imaginary vertical planes VP. The imaginary vertical planes VP are hereinafter call “vertical basis planes”. As understood from in FIG. 1, which vertical basis plane VP is chosen depends on which support-plates 21 are chosen. The upper surfaces of four support-plates 21 are all on the same horizontal plane. This horizontal plane is hereinafter called “horizontal basis plane and designated by “HP” in FIG. 1.

Driver 13 drives arm 12 to receive substrate 9 at a position apart from the position where retainer 2 is provided, making arm 12 perform the expansion, the contraction, the rotation and the lifting motion adequately. Afterward, driver 13 locates substrate support 11 at a position higher than the horizontal basis plane HP, making support basis line S located one of vertical basis planes VP. In this operation, if the rotation of arm 12 and substrate support 11 is required, one of vertical basis planes BP is chosen so that angle of the rotation can be minimum. Speed of the rotation is made comparatively low.

Driver 13 contracts arm 12 to transfer substrate support 11 closer to retainer 2, keeping the relation that substrate support 11 is higher than the horizontal basis plane HP and support basis line S is on the vertical basis plane VP. When substrate support 11 reaches at a level higher than retainer 11, and the center of substrate 9 corresponds to the vertical line through the center of four support-plates 21, which is hereinafter called “retaining center axis”, driver 13 stops the movement of substrate support 11. The level at which substrate support 11 is stopped is hereinafter called “upper end level”.

From this situation, driver 13 lifts down arm 12 and substrate support 11 together. Driver 13 stops the lifting when the upper surface of substrate support 11 is located at a level lower than the horizontal basis plane HP with a specified distance. This level is hereinafter called “lower end level”. During this lifting-down motion, substrate 9 is placed on retainer 2 composed of four support-plates 21, completing the retention.

Next, substrate 9 is transferred to another position (hereinafter called “transfer-to-position”) . Specifically, driver 13 rotates arm 12 and substrate support 11 together at 90, −90, 180 or −180 degree (hereinafter ±90 or ±180 degree), keeping the relation that the upper surface of substrate support 11 is on the lower end level. The rotation angle is selected so that the direction of the support basis line S can be closest to the direction to the transfer-to-position. The lower end level is determined so that the upper surface of substrate support 11 can be lower than the down surface of each support-plate 21. Therefore, substrate support 11 is not interfered with support-plate 21 during the rotation.

After the described rotation of ±190 or ±180 degree, driver 13 lifts up arm 12 and substrate support 11 together. Driver 13 stops lifting when the upper surface of the substrate support 11 reaches at the upper end level. During this lifting-up motion, substrate 9 is placed on substrate support 11, dissolving the retention.

Next, driver 13 rotates arm 12 and substrate support 11 together so that the support basis line S is directed to the transfer-to-position, if it is necessary. Speed of the rotation is made comparatively low as well as described. Directing the support basis line S to the transfer-to-position, driver 13 expands arm 12 to advance substrate support 11, thereby transferring substrate 9 to the transfer-to-position.

In the composition and the operation of the substrate transfer system of this embodiment as described, the rotation for changing the direction of the expansion and the contraction of arm 12 is performed out without supporting substrate 9 on substrate support 11, by retaining substrate 9 temporarily on retainer 2. Therefore, the rotation with supporting substrate 9 is reduced as much as possible. In addition, the speed of the rotation is made low. Therefore, the possibility of the shift or the fall of substrate 9 by the inertia or the centrifugal force can be diminished.

Moreover, the transfer efficiency does not decrease much even if the rotation speed is made low, because the rotation angle is small. The speed of the rotation without supporting substrate 9 can be much high. This is more than offsetting the slowness of the speed of the rotation with supporting substrate 9. Therefore, the transfer efficiency as a whole can be enhanced.

The rotation angle is not limited to ±90 or ±180 degree. What is necessary is that substrate support 11 may not be interfered with retainer 2 when it is lifted up. Any angle can be chosen as far as substrate support 11 is not interfered. Range of the choice of the rotation angle also can be wider by changing the composition of retainer 2. For example, the composition where three support-plates are provided at every 120 degree can be adopted as retainer 2. With this composition, the range of the choice of the rotation angle can be wider than the described embodiment.

Next, a preferred embodiment of the substrate processing apparatus of the invention is described as follows.

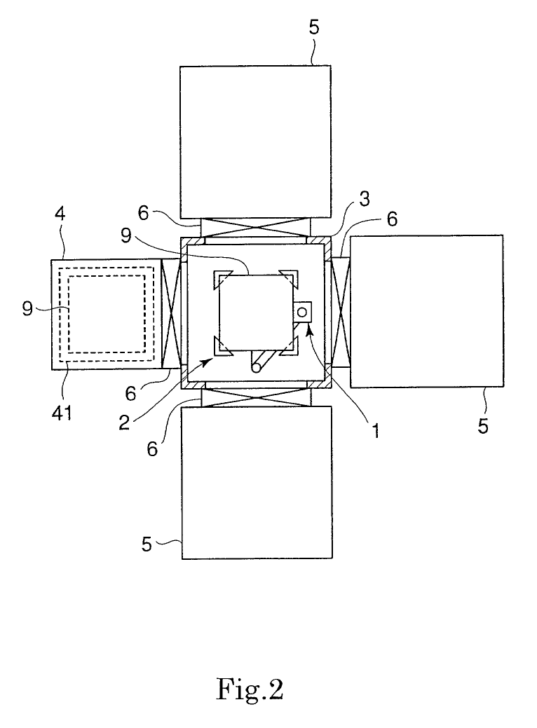

With the apparatus shown in FIG. 2, an idea of chamber layout so called “cluster-tool type” is adopted. Concretely, in the center there is a transfer chamber 3 comprising a substrate transfer system. Load lock chamber 4 and process chambers 5 are provided in the circumference of transfer chamber 3. Transfer chamber 3 has a square shape in a plane view as shown in FIG. 1. Each process chamber 5 is connected on three sides of transfer chamber 3 respectively. Load lock chamber 4 is connected on the rest of the sides of transfer chamber 3. In the plane view, each process chamber 5 and load lock chamber 4 are also square. At each connection part, gate valve 6 is provided. Each chamber 3, 4, 5 is an airtight vacuum vessel. With each chamber 3, 4, 5, a pumping system (not shown) is provided.

For the substrate transfer system, it possible to use the same composition as the described embodiment. As shown in FIG. 2, the retaining center axis corresponds to the center of transfer chamber 3. Each side of the square made of support-plates 21 is parallel respectively to each side of the plane view outline of transfer chamber 3. Lines drawn from the center axes of process chamber 5 and load lock chamber 4 to the center axis of transfer chamber 3 are perpendicular to each side of transfer chamber 3 respectively. The fixation rods (not shown in FIG. 2) holding each support-plate 21 are fixed with the upper wall of transfer chamber 3.

Load lock chamber 4 is the chamber in which substrate 9 temporarily stays while it is transferred between the atmosphere and transfer chamber 3. In load lock chamber 4, a cassette 41 which temporarily contains substrate 9 is provided.

Process chamber 5 has substrate holder 51 that holds substrate 9 on the upper surface. Substrate holder 51 has a lifting mechanism such as one comprising lifting pins for passing and accepting substrate 9.

Process chamber 5 is composed adequately according to content of the process. For example, in the case of sputtering process, a target is provided in process chamber 5, facing to substrate holder 51. A pumping system which pumps gas out of process chamber 5 and a gas introduction system that introduces a process gas into process chamber 5 are also provided. Behind the target, a magnet unit for the magnetron sputtering is provided.

Introducing a process gas like argon into process chamber 5, sputter discharge is ignited by applying negative high voltage or RF (radio-frequency) voltage with the target. Material released from the target though the sputter discharge reaches to the surface of substrate 9, thereby depositing a thin-film.

In case that the substrate processing is a plasma chemical vapor deposition (CVD), an electrode for generating a plasma is provided in process chamber 5. Process chamber 5 comprises a pumping system for pumping itself, a gas introduction system for introducing a process gas into itself, an RF source for applying RF voltage with the electrode to ignite RF discharge. In the plasma generated though the RF discharge, a gas phase reaction is caused, resulting in that a thin-film is deposited on the surface of substrate 9.

In addition, in case that the substrate processing is a plasma etching, almost the same composition as in case of the plasma CVD is employed, except that an etchant gas like a fluorine compound gas is introduced into process chamber 5. Utilizing an effect of activated fluorine species produced in the plasma, the surface of substrate 9 is etched.

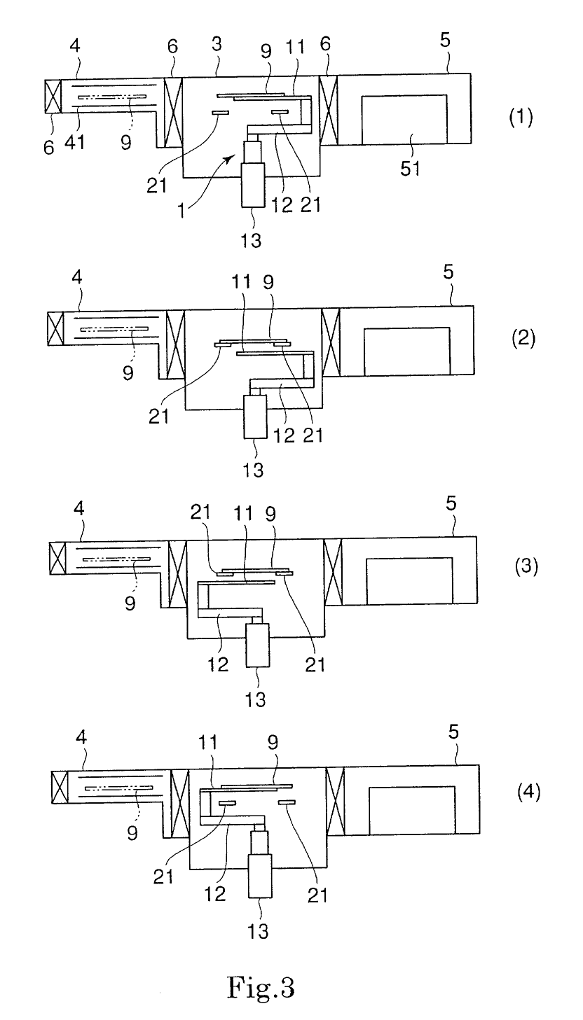

Next, operation of the substrate processing apparatus of this embodiment is described using FIG. 3. FIG. 3 shows the operation progresses the order of (1)˜(4).

Unprocessed substrates 9 are contained in an outside cassette (not shown) . An auto-loader (not shown) which transfers substrate 9 between the outside cassette and load lock chamber 4 is provided. Unprocessed substrate 9 is transferred from the outside cassette to load lock chamber 4 by the auto-loader. Substrate 9 is contained temporarily in cassette 41.

Transfer robot 1 of the substrate transfer system expands arm 12 to load lock chamber 4 to accept substrate 9 from cassette 41. Substrate 9 is placed on substrate support 11. Transfer robot 1 contracts arm 12 to move back substrate support 11 supporting substrate 9. Substrate support 11 is located the upper end level as shown in FIG. 3 (1).

A line through which the center of substrate 9 should pass while substrate 9 is transferred from load lock chamber 4 to transfer chamber 3, which is hereinafter called “transfer line”, corresponds to the line horizontally drawn from the center axis of load lock chamber 4 and the center axis of transfer chamber 3. As understood from FIG. 1 and FIG. 2, the transfer line is on one of vertical basis planes VP in the substrate transfer system. During transferring substrate 9, transfer robot 1 moves substrate support 11 so that the support basis line S moves along the transfer line.

From the situation shown in FIG. 3 (1), transfer robot 1 lifts down arm 12 and substrate support 11 together, thereby passing substrate 9 to retainer 2. Afterward, transfer robot 1 rotates substrate support 11 and arm 12 together at ═90 or ±180 degree. The rotation angle depends on which process chamber 5 shown in FIG. 2 substrate 9 is transferred to. In the example shown in FIG. 3, the rotation angle is +180 or −180 degree because substrate 9 is transferred to process chamber 5 facing to load lock chamber 4.

After finishing the rotation, transfer robot 1 lifts up substrate support 11 and arm 12 together to the upper end level, thereby accepting substrate 9 on substrate support 11. Transfer robot 1 expands arm 12 to transfer substrate 9 to process chamber 5. In process chamber 5, substrate 9 is passed from substrate support 11 to substrate holder 51 through the mechanism such as lifting pins (not shown)

After finishing the process, transfer robot 1 accepts substrate 9 on substrate support 11 and contracts arm 12. Transfer robot 1 lifts down arm 12 and substrate support 11 together down from the upper end level to the lower end level, thereby passing substrate 9 to retainer 2. Transfer robot 1 rotates arm 12 and substrate support 11 together at ±90 or ±180 degree according to a position of process chamber 5 to which substrate 9 is transferred next. Transfer robot 1 successively transfers substrate 9 to every process chamber 5 by repeating the same operation. After finishing the process in last process chamber 5, processed substrate 9 is returned to load lock chamber 4. Processed substrate is taken out of load lock chamber 4 to the atmosphere by the auto-loader (not shown).

As understood from the above description, there is no rotation with supporting substrate 9 in the apparatus of this embodiment. In other words, only by the rotation without supporting substrate 9, the direction of the expansion and the contraction of arm 12 is changed. Therefore, the shift or the fall of substrate 9, which might be caused by the rotation of substrate support 11 with supporting substrate 9, never occurs. In addition, it is not required to chuck substrate 9 on substrate support 11 by electro-static force, because of no rotation with supporting substrate 9.

Though three process chambers 5 are provided around transfer chamber 3 in this embodiment, the invention is not limited to that. More process chambers 5 can be connected by using a pentagon shaped transfer chamber, a hexagon shaped transfer chamber or more. In these modifications, composition of retainer 2 is also modified adequately so that the operation to change the direction of the expansion and the contraction of arm 12 does not involve the rotation of arm 12 and substrate support 11 with supporting substrate 9. It is preferable that substrate support 11 may not be interfered with retainer 2 when substrate support 11 is lifted up making the support basis line S correspond to the transfer line. Even in case substrate support 11 is lifted up avoiding retainer 2 because the interference would be inevitable, the angle of the rotation for coordinating the direction is preferably made as small as possible.

Retainer 2 may be composed of five or more support-plates 21. In addition, retainer 2 may have the composition where substrate 9 is held by hooks or nippers, or the composition that substrate 9 is place on a stage provided at the center in transfer chamber 3.

Transfer robot 1 is not limited to the described composition as well. For example, it is possible to adopt a robot having a combination of arm rods that performs a symmetric motion such as disclosed in the Japanese domestic laid-open No. 8-506771.

Square substrate 9 in the above described embodiment is assumed a glass substrate for a LCD. Other than that, square substrate 9 may be a substrate for another kind of display device like a plasma display, a substrate for a solar cell, or a substrate for a printed circuit. The invention can be applied to substrates other than the square substrate. For example, the invention can be applied to circular substrates like semiconductor wafers and disk-shaped substrates like information-storage disks.

The point that square substrate 9 may not be rotated has the great advantage in relation with the adoption of square transfer chamber 3. If square substrate 9 must be rotated, the required minimum radius would correspond to half of the diagonal of substrate 9. Therefore, even if the rotation is coaxial to the center axis of transfer chamber 3, a round space with this radius is at least required inside transfer chamber 3 (practically, clearance necessary between the wall of transfer chamber 3 and the edge of substrate 9 is required additionally). On the other hand, if substrate 9 is not rotated, the inside space of transfer chamber 3 may be the size made by adding the size of substrate 9 and the clearance. Therefore, the size of transfer chamber 3 can be smaller.

What is claimed is:

1. A substrate transfer system comprising:
a transfer robot which transfers a substrate;
a retainer which temporarily retains said substrate while said substrate is transferred;
said transfer robot having an arm at which fore end a substrate support for supporting said substrate is provided, and a driver which makes said arm perform expansion, contraction, rotation and lifting motion, thereby transferring said substrate to a position;
whereby said substrate is retained temporarily with said retainer while said transfer robot rotates said arm and said substrate support together to change the direction of said expansion and said contraction motion of said arm, thus said rotation for changing said direction is performed without supporting said substrate.

2. A substrate transfer system as claimed in claim 1, wherein said substrate is square.

3. A substrate processing apparatus comprising:
a process chamber in which a process is carried out on a substrate;
a load lock chamber in which said substrate stays temporarily while said substrate is transferred to said process chamber;
a transfer chamber in which a substrate transfer system is provided;
said substrate transfer system transferring said substrate between said load lock chamber and said process chamber; and
said substrate transferring system having an arm at which fore end a substrate support for supporting said substrate is provided, and a driver which makes said arm perform expansion, contraction, rotation and lifting motion, thereby transferring said substrate to a position;
whereby said substrate is retained temporarily with said retainer while said transfer robot rotates said arm and said substrate support together to change the direction of said expansion and said contraction motion of said arm, thus said rotation for changing said direction is performed without supporting said substrate.

4. A substrate processing apparatus as claimed in claim 3, wherein said substrate is square.

5. A substrate processing apparatus comprising:
a plurality of process chambers in which a process is carried out on a substrate;
a load lock chamber in which said substrate stays temporarily while said substrate is transferred to one of said process chambers;
a transfer chamber in which a substrate transfer system is provided;
said substrate transfer system transferring said substrate between said load lock chamber and one of said process chambers or between two of said process chambers; and
said substrate transferring system having an arm at which fore end a substrate support for supporting said substrate is provided, and a driver which makes said arm perform expansion, contraction, rotation and lifting motion, thereby transferring said substrate to a position;
whereby said substrate is retained temporarily with said retainer while said transfer robot rotates said arm and said substrate support together to change the direction of said expansion and said contraction motion of said arm, thus said rotation for changing said direction is performed without supporting said substrate.

6. A substrate processing apparatus as claimed in claim 3, wherein;
said retainer does not interfere with said substrate support when said substrate support is lifted up in state that a direction of said expansion said contraction of said arm corresponds to a transfer line.

7. A substrate processing apparatus as claimed in claim 3, wherein:
said retainer is composed of four support-plates provided at each corner of a square;
said transfer chamber has a square shape in plane view which is coaxial with the center of said four support-plates;
each side of said square in said plane view of said transfer chamber and each side of said square at which corners said support-plate are provided are parallel to each other;
said process chamber is connected airtightly on a side of said square in said plane view of said transfer chamber;
said load lock chamber is connected airtightly on another side of said square in said plane view of said transfer chamber;
the line drawn from the center of said transfer chamber to the center of said process chamber is perpendicular to said side on which said process chamber is connected;
the line drawn from the center of said transfer chamber to the center of said load lock chamber is perpendicular to said side on which said load lock chamber is connected.
